(19) United States
(12) Patent Application Publication
(10) Pub. No.: US 2010/0118900 A1
(43) Pub. Date: May 13, 2010

(54) Generation of profiled light packets

(76) Inventors: Robert G. Waarts, Los Altos, CA (US); Gregory J.R. Spooner, San Francisco, CA (US)

Correspondence Address: CARR & FERRELL LLP, 2200 GENG ROAD, PALO ALTO, CA, 94303, US

(21) Appl. No.: 12/291,919

(22) Filed: Nov. 13, 2008

(51) Int. Cl. H01S 3/10

(52) U.S. Cl. 372/25

(57) ABSTRACT

Exemplary systems and methods are directed toward the creation of packets of light. A packet contains one or more pulses of light. In some embodiments, the packet may contain two, ten, 100, 1000, 1E6, or more pulses of light. The packet may be characterized by many of the same properties that are used to describe pulses, such as packet energy, packet width, packet power, packet period (for a periodic series of packets), and peak power of the packet. Packets may also be characterized by other properties describing their shapes. These properties may be described or defined by mathematical functions when the packets have complicated shapes.

### CROSS REFERENCE TO RELATED APPLICATIONS

The present Application is related to U.S. patent application Ser. No. 11/563,957 entitled “Pulse Selecting in a Chirped Pulse Amplification System” filed on Nov. 28, 2006, which is incorporated herein by reference.

### BACKGROUND

1. Technical Field

The present invention relates generally to sources of pulsed light, and more particularly to generation of light packets having desired energies and power profiles.

2. Description of Related Art

Behavior of a substance when exposed to incident radiation is often associated with a response time of a physical process. For some discrete events that repeat much faster than a relevant response time (and do not damage the substance), the substance may respond to a series of events as if a continuous process is occurring. This effect is used in a variety of arts. For example, a video may comprise discrete images of a moving object projected at a high rate (e.g., 30 images per second), such that a viewer interprets these images as continuous motion of the object. Thus, in many instances, a sufficiently fine and/or rapid discretization of an input may create a same response as if the input were continuous.

Continuous wave lasers and pulsed lasers are each used in a variety of applications, although applications that require continuous wave lasers are typically different than those that require pulsed lasers. One of the main differences can be power required by the application. By choosing a pulsed laser, a very high instantaneous power (e.g., over one megawatt or even over one gigawatt) can be generated, which can induce a rich variety of interactions with substances illuminated by the laser. However, pulsed laser systems generally do not provide continuous power. As such, many applications that require light of relatively uniform power cannot use pulsed lasers.

FIG. 1 shows several parameters that can describe light from a typical pulsed light source, such as a pulsed laser. These parameters include a peak power 110 per pulse, a pulse width 120, shown as a width of a pulse at half of the peak power 110, and a period 130 between pulses (often referred to in the inverse, as a repetition rate). The integrated power of the pulse (e.g., over the pulse width) can be described as a pulse energy or energy per pulse, and the product of pulse energy and repetition rate can yield the average power of the light source. Typically, the average power of a pulsed light source (e.g., a few watts) may be much lower than the power of a single pulse (e.g., a few gigawatts).

Although the energy of a single pulse may be relatively small (e.g., less than 0.1 Joules, or even less than 10 microjoules), a very short pulse width (e.g., less than 1 nanosecond, or even 1 picosecond) may yield a high peak power (e.g., greater than 10 Megawatts or even greater than 100 Megawatts).

Pulsed lasers can often only provide pulses within a limited range of pulse properties (e.g., period, power, width, and energy). Thus, a desired response or property of interest in a substance being irradiated largely determines a type of pulsed laser required, and other responses or properties may not be available with a chosen type of pulsed laser. As such, the range of available pulse properties from a given light source largely determines the types of applications that can be addressed with that light source.

The response of a substance to irradiation is often affected by a relationship between power of the radiation and relevant response times of different physical processes in the substance (e.g., thermal conductivity). For typical continuous wave irradiation, power may be sufficient to cause heating, melting, or even evaporation of the substance. For pulsed lasers having relatively low pulse powers, a variety of linear interactions between the light and the substance are possible, such as heating or linear excitation processes. However, in situations having very high power available with some pulsed laser sources, the input of pulse energy to the substance can be much faster than the substance's ability to dissipate the energy. As pulse widths are shortened from millisecond to nanosecond to picosecond to femtosecond (or even sub-femtosecond), pulse powers can increase dramatically (e.g., to greater than 1 kilowatt, 1 megawatt, or even beyond 1 gigawatt). For these high power pulses, a variety of electronic or nonlinear interactions are possible, such as ablation of a surface or nonlinear molecular processes.

However, it can be challenging to generate light over a broad enough range of powers that the same device can cause diverse responses (e.g., both linear and nonlinear) in a substance. Although pulses can be removed to decrease average power (e.g., by increasing the period 130 between emitted pulses), the pulse power is largely a function of a chosen light source. Thus, the choice of light source may largely determine availability of different possible interactions with a given substance, and creating a broad range of responses often requires the use of multiple light sources.

### SUMMARY OF THE INVENTION

Exemplary embodiments include a light source having a pulse generator capable of generating a first series of light pulses. In some embodiments, the light pulses may be characterized by a pulse width of less than 10 nanoseconds, and the first series of light pulses may be characterized by a first period. The light source may also include a pulse picker capable of receiving the first series of light pulses and transmitting a second series of light pulses, the second series being characterized by a second period. The light source may further include a packet shaper capable of receiving the second series of light pulses and transmitting one or more packets, each packet comprising one or more pulses. Additionally the light source may also include a controller in communication with the pulse generator, pulse picker, and packet shaper, and configured to control packet power.

In some embodiments, the pulse width generated by the light source is less than 100 picoseconds. In other embodiments, at least some of the packets are characterized by a packet width of greater than one nanosecond.

Various embodiments include an amplifier disposed between the pulse picker and packet shaper, and configured to amplify the light pulses. Certain embodiments may also include a stretcher to stretch the light pulses and/or a compressor to compress the packets of light pulses. In some embodiments, the amplified energy of a pulse is controlled by controlling a pumping of the amplifier prior to an amplification event. In certain embodiments, amplification of pulses and/or packets may be controlled by controlling a periodicity or other time dependency of light pulses entering the amplifier for amplification.

Some embodiments control pulse energy by controlling a gain of the amplifier. In other embodiments, pulse energy may be controlled by partially blocking or attenuating pulses prior to amplification.

Certain embodiments may include a mode locked laser to generate pulses. In some cases, either the pulse picker or packet shaper comprises an optical modulator selected from a group consisting of an acousto-optic modulator, an electro-optic modulator, a Pockels Cell, a micro-mirror, and a long period fiber grating.

In some embodiments, at least some of the packets are characterized by a packet width of greater than one nanosecond. In some cases, packet power may be controlled to be between 10 watts and 1 gigawatt. Packets having different widths, energies, and powers may be emitted. In some cases, some packets have powers over one megawatt and other packets have power less than 100 kilowatts.

Various embodiments include a method of emitting one or more packets of light. Each packet may include one or more pulses of light, and each packet may be described by a packet width, packet energy, and packet power. The method includes receiving a request for one or more packets, wherein the request includes a desired packet energy, packet width, and packet power. The method continues with a calculation of a set of packet properties based on the request. The set of packet properties may include one or more properties describing the light pulses within the packet. Light pulses are then generated according to the set of packet properties. In some embodiments, the light pulses may be amplified to achieve a desired energy. A packet shaper may then be used to shape the amplified pulses into one or more packets according to the set of packet properties. The packets are then emitted.

Some embodiments may emit a packet having a power that induces a linear response in a substance being illuminated. Some embodiments may emit a packet having a power that induces a nonlinear response in a substance being illuminated. Certain embodiments include emitting a first packet having a power that induces a linear response in a material being illuminated and a second packet having a power that induces a nonlinear response in a material being illuminated. Some embodiments include a system for treating tissue (e.g., human, animal, or plant tissue, skin, flesh, eye tissue and the like).

### BRIEF DESCRIPTION OF THE DRAWINGS

FIG. 1 depicts several parameters describing light from a pulsed light source according to the prior art.

FIG. 2A is a block diagram of an exemplary device for generating profiled light packets according to select embodiments.

FIG. 2B shows several schematic representations of changing pulse energies as related to amplifier charging time.

FIG. 3 is an exemplary series of profiled light packets according to select embodiments.

FIG. 4 is another exemplary series of profiled light packets according to select embodiments.

FIG. 5 is another exemplary series of profiled light packets according to select embodiments.

FIG. 6 is a flowchart describing an exemplary method for generating profiled light packets according to select embodiments.

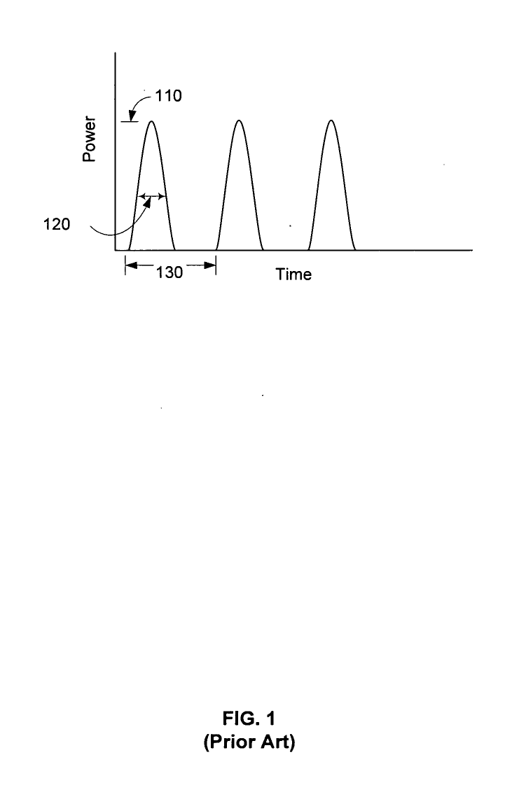

### DETAILED DESCRIPTION OF EXEMPLARY EMBODIMENTS

Embodiments of the present invention are directed toward light sources providing a wide range of irradiation power. In some embodiments, the range may be wide enough that the same light source can be operated to create both linear and nonlinear responses in a substance being irradiated. More specifically, pulsed laser sources capable of creating nonlinear responses in substances may be adapted to provide a range of power such that both linear and nonlinear responses can be created.

Exemplary systems and methods are directed toward creating packets of light. The packet may contain one or more pulses of light. In some examples, the packet may contain two, ten, 100, 1000, 1E6, or more pulses of light. The packet may be characterized by many of the same properties that are used to describe pulses, such as packet energy, packet width, packet power, packet period (for a periodic series of packets), and peak power of the packet. The packets may also be characterized by other properties describing their shapes. These properties may be described or defined by mathematical functions when the packets have complicated shapes. In some embodiments, the packet widths may be as small as a few milliseconds, a few nanoseconds, a few picoseconds, or even a few femtoseconds. In other embodiments, the packet widths may be as long as desired, (e.g., greater than one nanosecond, one microsecond, one second, or even ostensibly “infinite” as needed by an application). In some embodiments, packets may be created having packet widths substantially longer than the pulse widths of the pulses contained therein. The packet power, or the packet energy divided by the packet width, may be a convenient way to characterize a packet. Packet powers may range from less than one milliwatt to over one gigawatt. In some embodiments, the range may be between 10 watts and 100 megawatts.

In some embodiments, the packet may create substantially the same response in a substance being irradiated as would a pulse having the same properties (e.g., width, energy, power, and/or shape) as the packet, particularly when the packet is comprised of several or more pulses having powers below a transition between linear and nonlinear interactions with the substance. This similarity may be improved by choosing a period of pulses within the packet that is substantially shorter than a given response time of the substance being irradiated, such that a plurality of pulses may arrive at the substance faster than the substance responds to the pulses.

Although pulses and packets can be created with any light source, it may be advantageous to use a pulsed light source having a very short pulse period (e.g., less than 10 milliseconds, less than 1 millisecond, less than 100 nanoseconds, less than 10 nanoseconds, or even less than 1 nanosecond), in accordance with some embodiments. For some applications, it may also be advantageous to generate pulses having a very small width, (e.g., less than 10 nanoseconds, less than 1 nanosecond, less than 100 picoseconds, or less than 10 picoseconds). Various applications may benefit from the use of ultrashort pulses, or pulses having widths below 10 picoseconds, below 100 femtoseconds or even below 10 femtoseconds. Mode-locked lasers may be capable of generating picosecond or femtosecond pulses, and may include post-generation amplification for some applications. This amplification may be accomplished with an amplification system, an example of which may include a pulse stretcher, an amplifier, and a pulse compressor.

Several exemplary embodiments are directed toward pulse generation using mode-locked lasers. These systems may incorporate post-generation amplification. However, substitute light sources (including sources not requiring post-generation amplification) are within the scope of the invention. Additionally, light sources having higher as-generated pulse energies (e.g., Q-switched lasers, gain switched laser diodes, or excimer lasers) may be used for pulse generation and packet generation directed toward responses having time scales appropriate to respective pulse widths and repetition rates of such light sources.

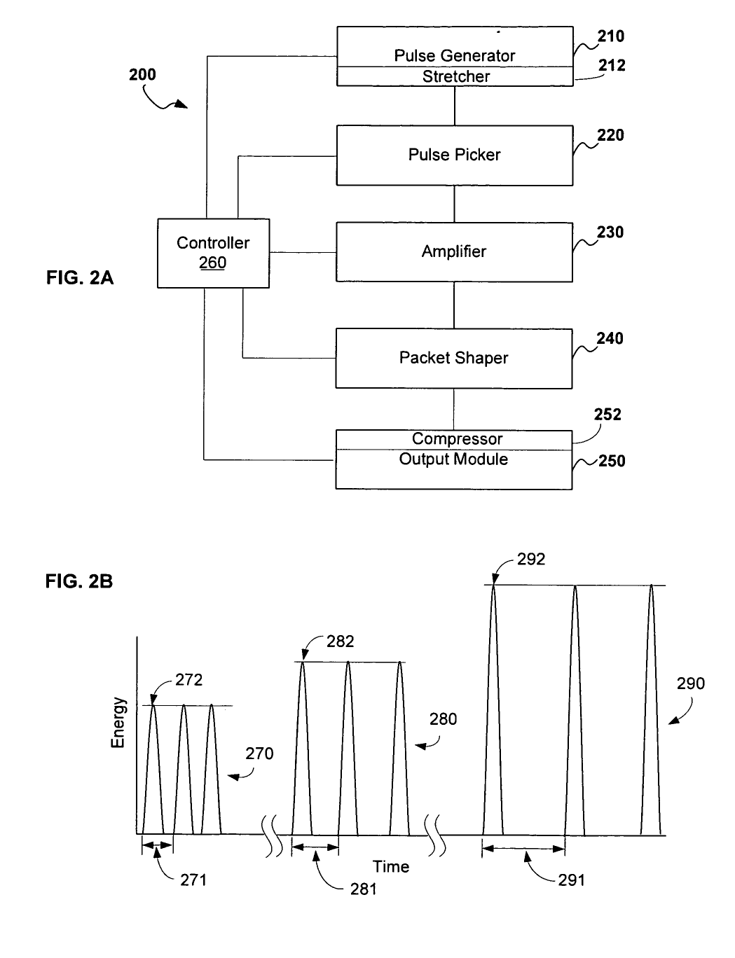

FIG. 2A is a block diagram of an exemplary light source 200 according to one embodiment. The light source 200 may comprise a pulse generator 210, a pulse picker 220, an amplifier 230, and a packet shaper 240. Output of the light source 200 is via an output module 250. The exemplary light source 200 includes the amplifier 230, although embodiments not requiring amplification subsequent to pulse generation are within the scope of the invention. The various components of the light source 200 are controlled by a controller 260, which may also provide for user input/output.

The pulse generator 210 may include an optional stretcher 212. Likewise, output module 250 may include an optional compressor 252. The pulse generator 210 is configured to generate light pulses, and will typically generate a series of light pulses having a certain period. Pulses may be characterized by a peak energy, a pulse width, and/or a pulse power and pulse energy. Pulse generator 210 will often include a pulsed laser, and may comprise a ring laser, a mode-locked laser, a laser oscillator, or other light source.

Amplification of the output from some pulsed light sources is often accomplished using Chirped Pulse Amplification (CPA). In such embodiments, the stretcher 212 may be incorporated into the pulse generator 210. The stretcher 212 can be designed to dispersively “chirp” the pulse temporally, increasing the pulse width, which may allow higher amplification without amplifier damage. The stretcher 212 may comprise a dispersive fiber, an acousto-optic tunable filter, a fiber Bragg grating, a Bragg fiber, a photonic crystal fiber, or the like.

In such embodiments, the output module 250 may also include the compressor 252. The compressor 252 may substantially compress the pulse back to a small pulse width, and by extension, compress the packets based on these pulses. In some embodiments, the compressor 252 comprises an air-path between bulk optical gratings, such as a Treacy compressor. In other embodiments, the compressor 252 comprises a fiber Bragg grating, a Bragg fiber, a photonic crystal fiber, a Volume Bragg Grating, or the like.

In some embodiments, the pulse picker 220 blocks some of the series of pulses generated by the pulse generator 210, allowing a subset of pulses to pass to the amplifier 230. For a pulse generator outputting pulses having a period of the order 10-100 nanoseconds, the pulse picker 220 may output pulses having a period of the order of 1-10 microseconds. The pulse picker 220 may comprise an optical modulator, such as an electro-optic modulator (EOM), an acousto-optic modulator (AOM), a Pockels Cell, a micro-mirror, a long period fiber grating, an idler laser, or the like. In exemplary embodiments, the pulse picker 220 receives timing input from the pulse generator 210 via the controller 260. The controller 260 may also control the timing between the pulse picker 220 and the packet shaper 240.

In exemplary embodiments, pulses may pass from the pulse picker 220 to the amplifier 230. The amplifier 230 amplifies pulses received from the pulse picker 220. The amplifier 230 may be a fiber-amplifier pumped by pump diodes. In some embodiments, the amplifier 230 may also be a semiconductor optical amplifier. In yet other embodiments, the amplifier 230 can be a solid state optical amplifier, (e.g., Nd:YAG or Yb:YAG or an amplifying medium made of mixed glasses). The amplifier 230 can be a component of an amplification system, which can include various apparatus necessary for amplification, such as a pulse stretcher and pulse compressor.

The amplified pulses may then be passed from the amplifier 230 to the packet shaper 240. The packet shaper 240 may be configured to remove or attenuate amplified pulses, thereby allowing one or more packets of pulses to pass. The pulses passed by the packet shaper 240 create packets of pulses. Each packet contains one or more pulses, and may be separated from another packet by a time period during which no packets are emitted. In some embodiments, the packet shaper 240 creates a series of packets, in which each packet includes one or more pulses, packets are separated by a packet period, and no pulses occur between two sequential packets.

In exemplary embodiments, the controller 260 allows for user input and output, and thus may comprise a user interface. User input may include a desired packet shape, packet energy, packet width, packet power, packet period, or any other characteristics of the emitted radiation that may be desired. The user may also specify various properties of the pulses included in the packets, such as pulse width, pulse energy, pulse power, number of pulses in a packet, period between pulses in a packet, or other parameters. In other embodiments, the controller 260 may calculate these latter pulse properties from the user's input of desired packet properties.

The user interface may be a software program operating on a processor, and the program may be stored in memory or on some sort of computer readable storage medium. The user interface may include input and output hardware such as a display, keyboard, and mouse. The user interface may also provide information (e.g., light pulse quality or operating conditions) to the user. The user interface may optionally include sensors directed toward a substance being irradiated, and in some embodiments, the response of a substance being irradiated by the light source 200 may be used to at least partially control the light source 200.

For embodiments including the amplifier 230, control of amplification may be accomplished in a variety of ways. In some embodiments, the pulse picker 220 may be operated to attenuate or partially block a pulse. This attenuation may reduce the pulse energy prior to amplification and thus reduce the amplified pulse energy. The gain setting of the amplifier 230 may also be controlled. For amplifiers that “charge” continuously with time, amplification typically increases with elapsed time since the previous discharge (e.g., since the last pulse passed through the amplifier). Thus, increasing a time period between pulses can result in higher amplified pulse energies.

In exemplary embodiments, ultrashort pulses may be generated by a pulse generator 210 comprising a mode locked laser, and passed from the pulse generator 210 through the stretcher 212 which may include a fiber grating or bulk grating. Stretched pulses then pass to the pulse picker 220, which may include an acousto-optic modulator or electro-optic modulator, and which removes some pulses from a series of pulses. The remaining pulses pass to the amplifier 230, which may comprise a rare-earth doped fiber with a pump source matched to the absorption of the fiber. Pulses may then pass to the packet shaper 240, which may include an acousto-optic modulator or electro-optic modulator. Packet shaper 240 removes and/or attenuates pulses to shape packets for output. The packets of amplified pulses pass through the compressor 252, which may comprise a bulk grating or other wavelength selective element (e.g., a prism). The compressed packets are then output from the system at output module 250. In this implementation, pulse generator 210 may generate pulses in the range of 10 femtoseconds to 10 picoseconds, at a period of 1 nanosecond to 100 nanoseconds. An acousto-optic modulator (AOM) may be driven by radio-frequency (RF) power, which may be controlled to vary the output of a device incorporating the AOM (e.g., a pulse picker or a packet shaper). Modulators such as an electro-optic modulator (EOM) may have continuously attenuated output as well.

FIG. 2B shows several schematic representations of how pulse energy can be increased by increasing amplifier pumping time (e.g., by increasing pulse period). Three separate series of pulses are shown, after each has passed through an amplifier such as the amplifier 230. Each series 270, 280, and 290 is characterized by periods 271, 281, and 291, respectively. The length of the period 291 is greater than that of the period 281, which is greater than that of the period 271. For constant gain settings, increasing the period can result in increased pulse energy or pulse peak energy as shown. Thus, the magnitudes of pulse peak energies 292, 282 and 272 correlate with the lengths of periods 291, 281, and 271, respectively. Period 291 results in higher energy pulses than does the period 281, and the period 281 results in higher energy pulses than does the period 271. In some embodiments, pulse energy may be controlled by controlling driver current of the amplifier.

Too long of a period between pulses may result in Amplified Spontaneous Emission (ASE), an uncontrolled discharge that may be deleterious to performance. Thus for a given gain setting, a series of pulses to the amplifier 230 may be characterized by a period (e.g., a period 130) less than (e.g., 90%, ⅓, 1/10^{th}, or 1/100^{th} of) the time required for ASE. For amplifiers not susceptible to ASE, pulses can be generated as needed or as convenient.

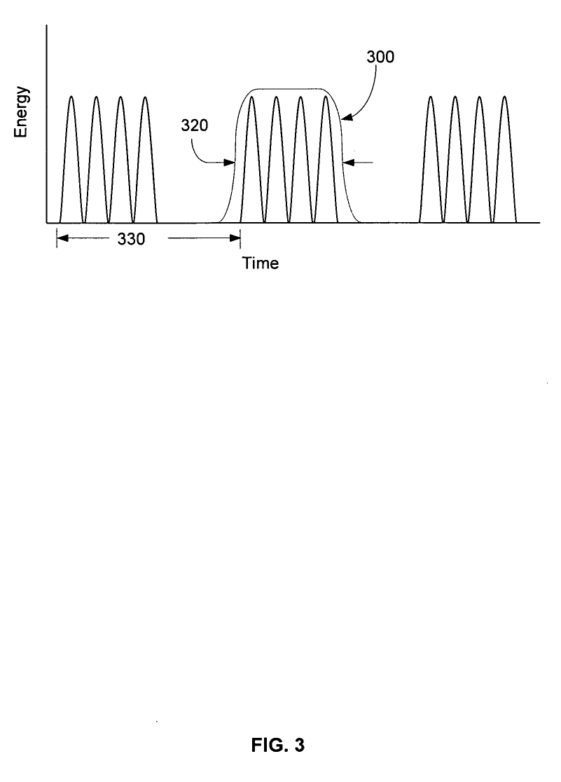

FIG. 3 is an example of a series of packets 300 that may be created using the light source 200. The series of packets 300 may be created by blocking one or more pulses from the amplifier 230. Each of the packets 300 may be characterized by a packet width 320. In this series, packets 300 are emitted regularly, and the time between sequential packets 300 is characterized by a packet period 330. The packet 300 may be further characterized by a packet peak energy that corresponds to the peak energies of the pulses contained within. The packet 300 may also be characterized by a packet energy corresponding to the integrated energy of the pulses within the packet.

For example, the pulse generator 210 may create a series of pulses having a width of 10 picoseconds and a period of 10 nanoseconds. The pulse picker 220 may output a series of pulses having a period of 10 nanoseconds. The pulses are amplified by the amplifier 230 such that each pulse has a pulse energy of 0.1 microjoule. The pulses are then passed to the packet shaper 240, which allows, for example, packets of eleven pulses to pass, with some pulses removed within each packet such that each pulse in a packet separated by 50 nanoseconds. The packet shaper 240 also removes pulses between the packets, yielding, for example, a packet period 330 of 100 milliseconds. Each resulting packet has a width of 500 nanoseconds and a packet energy of 1.1 microjoules, yielding an average packet power of 2.2 watts. Appropriate focusing of such packets may induce a linear response in a substance.

In another example, the pulse generator 210 may create a series of pulses having a width of 10 picoseconds and a period of 10 nanoseconds. The pulse picker 220 may output a series of pulses having a period of 100 nanoseconds. The pulses are amplified by the amplifier 230 such that each pulse has a pulse energy of 10 microjoules. The pulses are then passed to the packet shaper 240, which allows, for example, packets of three pulses to pass, with 100 nanoseconds between each pulse. The packet shaper 240 removes pulses between the packets, yielding, for example, a packet period 330 of 1 millisecond. Each resulting packet has a width of 300 nanoseconds and a packet energy of 30 microjoules, yielding an average packet power of 100 watts. Appropriate focusing of such packets may induce a nonlinear response in a substance.

In another example, the pulse generator 210 may create a series of pulses having a width of 10 picoseconds and a period of 10 nanoseconds. The pulse picker 220 may output a series of pulses having a period of 10 microseconds. The pulses are amplified by the amplifier 230 such that each pulse has a pulse energy of 1 joule. The pulses are then passed to the packet shaper 240, which allows, for example, packets of a single pulse to pass, with 10 microseconds between each pulse. The packet shaper 240 removes pulses between the packets, yielding, for example, an initial packet period 330 of 1 millisecond. Each resulting packet has a width of 10 picoseconds and a packet energy of 1 joule, yielding an average packet power of 100 gigawatts. Appropriate focusing of such packets may induce a nonlinear response in a substance, and may be used to ablate a material. In some embodiments, the controller 260 may receive information associated with a desired ablation rate, which may generally correspond to a rate of packet emission. In some cases, the controller 260 dynamically controls the packet shaper 240, such that the packet period 330 varies in response to a measured ablation rate.

In other embodiments, a non-periodic output of packets is emitted. An example of this could be a series of packets in which each packet corresponds to a signal in a Morse code transmission. In certain embodiments, a single packet is emitted. In other embodiments, a packet is essentially continuous (e.g., the packet width is extremely large), and in these cases, may include some or all of the series of pulses from the pulse picker 220. In the case of a very long (e.g., continuous) packet, it may be useful to incorporate a variety of pulse energies within the packet. It may also be useful to further characterize a variation of packet energy over time, for example, by a sinusoidal component to a time dependence of the peak energy of the packet (e.g., the packet 300 may have a “wavy” top).

By choosing a pulse period within the packet 300 that is shorter than a given response time for a substance being irradiated, the response of the substance to the packet 300 may be substantially the same as if the substance were irradiated by an individual pulse having the properties of the packet 300. For example, a thermal time constant of an order of microseconds may be activated using low power packets having an internal pulse period of 100 nanoseconds, 10 nanoseconds, or smaller. In some embodiments, light sources, such as the light source 200, can create packets having properties (e.g., packet powers) that mimic the properties of light from other types of light sources (e.g., excimer lasers, Q-switched lasers, or continuous wave lasers).

The components of the light source 200 may be operated to at least partially decouple packet power from pulse power. The pulse picker 220 may be operated to change the amplified pulse energy by attenuating a pulse and/or controlling the pulse period of pulses passing to the amplifier 230, whose gain may also be controlled. The packet shaper 240 can then be used to determine which amplified pulses are incorporated into an output packet. Thus, the periodicity with which a substance is irradiated (e.g., the packet period 330) can be partially decoupled from the periodicity used to amplify each pulse (e.g., the pulse period). This decoupling may provide a range of packet powers that is broader than the range of pulse powers available from the pulse generator 210.

In some embodiments, pulses can be “shaped” into packets having desired properties (e.g., power, energy, and waveform). Packets having a range of power may be created, which may provide for responses ranging from linear to nonlinear. The packets may have asymmetrical (e.g., sawtooth) shapes, or may be used to simulate continuous wave irradiance by choosing relatively low power pulses and very large packet widths (or even a single, “infinitely long” packet). Packet shaping may be accomplished by controlling the pulse periodicity, by controlling the energy of pre-amplified pulses (e.g., by attenuating pulses prior to amplification), by controlling (e.g., attenuating with) the packet shaper, and/or by controlling amplifier gain (e.g., pumping or charging time).

Certain systems may be used to illuminate composite substances (e.g., skin). A packet may be shaped (e.g., having a power) such that it preferentially decomposes one part of an illuminated substance (e.g., a dark region) by creating a nonlinear response, yet leaves another part of the illuminated substance (e.g., normal skin) only slightly heated.

In some embodiments, a device comprising the light source 200 may create a range of packet powers. In certain embodiments, this range may be broad enough that both linear and nonlinear interactions with substances may be induced. By choosing a long period for the pulse picker 220 (e.g., approaching the ASE limit of amplifier 230) and a short period for packet shaper 240 (e.g., a few pulses or even one pulse per packet), high power packets may be created. Packet powers may be as high as the power of the most powerful amplified pulse (e.g., over one megawatt, over one gigawatt, or even over one terawatt), and as a result, nonlinear interactions with a substance may be created.

Alternatively, choosing a relatively short period for the pulse picker 220 (or otherwise creating low energy pulses) and a long packet period and/or packet width (via the packet shaper 240), lower power pulses (e.g., less than 10 kilowatts, less than 100 watts, less than one watt, or even less than a few milliwatts) can be output. These lower power pulses may cause substantially linear interactions with a substance. A user operating the controller 260 thus has the ability to tailor the nature of the irradiance as desired.

In some embodiments, a system may output in a “linear” mode and a “nonlinear” mode, with each mode creating either a linear or nonlinear response in a substance being irradiated. In some cases, a system may be switched between modes using autonomous control. Different modes may be programmed through a user interface, which may be included with a computer, laptop, PDA, telephone, or other device. In some embodiments, a system is controlled over the Internet, which may include IP and/or http protocols.

In some embodiments, a first mode may be used to analyze a substance (e.g., with a spectroscopic measurement), and a second mode may be used to treat or otherwise affect a surface being analyzed. Laser Induced Breakdown Spectroscopy (LIBS) may include the use of a nonlinear mode, and may be combined with a linear mode to provide for heating of a surface being analyzed.

The pulse picker 220 and packet shaper 240 may be driven by electrical signals which may be controlled by the controller 260, typically including a digital to analog (DA) converter. The gain of the amplifier 230 may be controlled by controlling the pump current to the amplifier. Pump current may also be controlled via a DA converter.

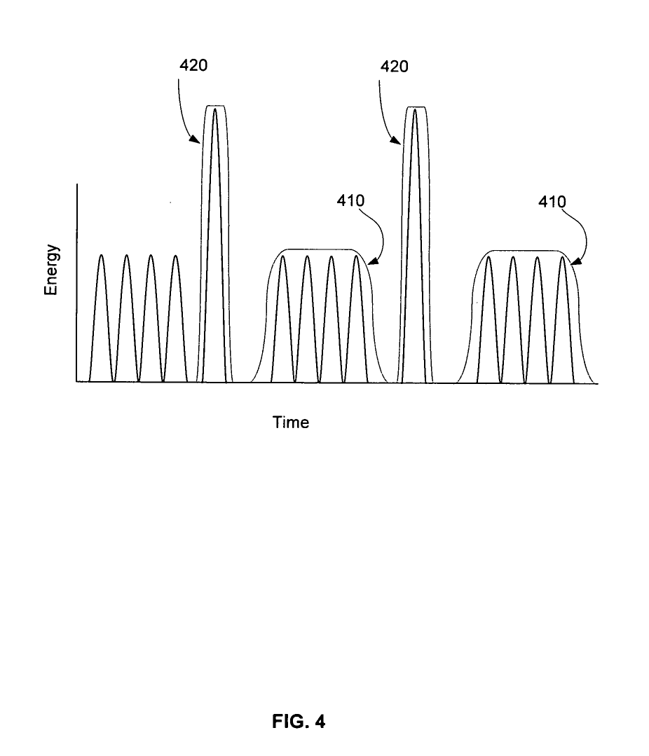

FIG. 4 shows an exemplary irradiance pattern comprising different packet types. Packets 410 include low energy pulses that cause linear interactions with a substance being irradiated. Each packet 420 includes a high energy pulse that causes a nonlinear interaction with a substance being irradiated. In this example, broad, low power (e.g., 10 watt) packets 410 may be used to heat a surface of a material being irradiated. These packets 410 may be interspersed with short, high power (e.g., 100 kilowatt) packets 420. These higher power packets 420 may cause a nonlinear response at the molten surface. Such a periodicity may be used to ablate a molten surface (or other nonequilibrium state) of a solid. Alternately, a spectroscopic measurement based on the high power, nonlinear pulses may be made on a molten surface (melted by the lower power pulses). As such, optical properties of liquid phases may be examined.

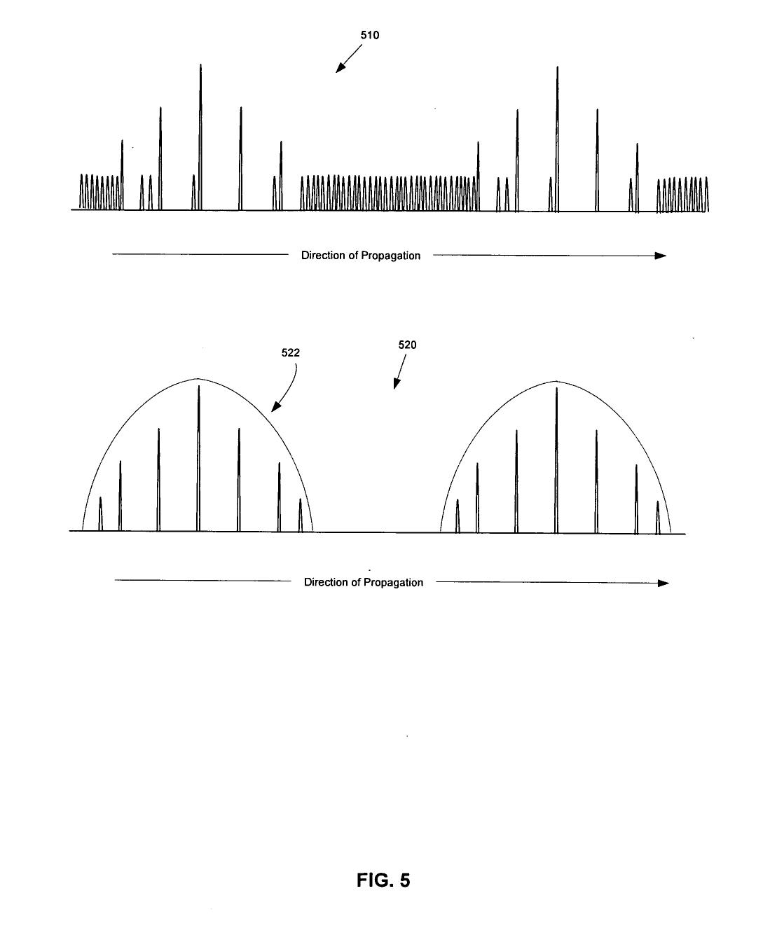

FIG. 5 shows how the exemplary light source 200, capable of generating a high power pulse (e.g., a pulse that would create a nonlinear response in an irradiated substance) may be used to create another series of packets that simulates a series of low power pulses. Pulse series 510 is a series of amplified pulses, in which the different amplification results from the combination of the pulse generator 210 and the pulse picker 220 controlling elapsed time between pulses passing through the amplifier 230. The pulse series 510 is passed to the packet shaper 240, which creates packet series 520. In this example, each packet 522 contains a set of ultrashort pulses, and is designed to simulate a much longer pulse having the shape of the packet 522. Additionally, the packet period may be much longer than the pulse period. Thus, a device that is capable of ultrashort, high power pulses (e.g., that can cause nonlinear interactions with substances) can be conveniently operated in a way that yields low-power packets having linear interactions with substances. In some embodiments, pulses may be tailored to yield packets having a desired “waveform.” In some embodiments, amplifier pumping current may also be used to change the power of amplified pulses, and by extension, change the “waveform” associated with a packet shape.

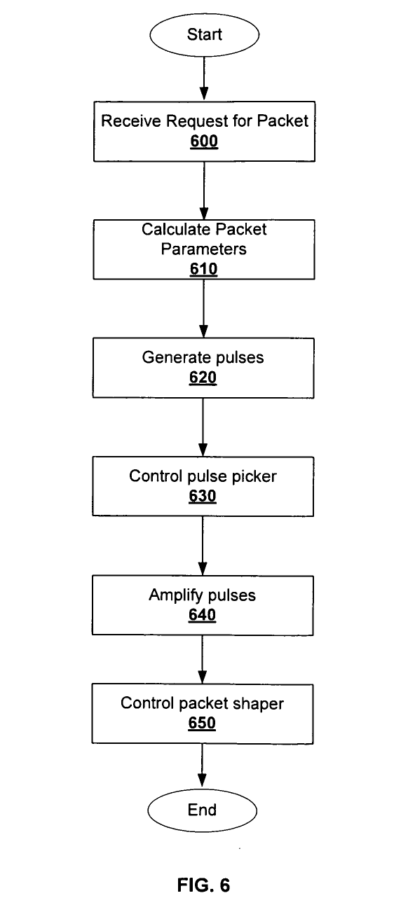

FIG. 6 is a flowchart of a method according to exemplary embodiments that incorporate amplification after pulse generation. The method can be applied to generation of one packet, and can be applied to generation of a plurality of packets by defining a time dependence of packet emission (e.g., the packet period or some other function describing packet emission versus time). For simplicity, the method is described in the context of generating a single packet.

In exemplary embodiments, a user operates the user interface to input a desired set of packet properties. There may be many or few properties, as needed by the user to define the packet appropriately. Generally, a user may input a desired packet energy, packet width, and packet power. The user may also input a desired packet profile or shape, number of packets, packet periodicity, or any other parameters needed to define the light output. The user may optionally input a desired number of pulses in a packet and the pulse energy, pulse width, and pulse power for any of these pulses. For packets having many pulses, the user may also input information such as pulse period or the distribution of pulses within the packet.

In some embodiments, the user interface is provided by the controller 260. In alternate embodiments, the user interface may be provided by a computing device (not shown) associated with the light source 200.

The controller 260 receives a request for a packet having desired properties in step 600. In step 610, the controller 260 calculates the necessary packet parameters required to generate the packet having the desired properties. If specific pulse information was not input by the user, the controller 260 may calculate an appropriate combination of pulse energy, pulse width, pulse period, pulse power, and other pulse-specific parameters such that the desired packet may be created. The result of step 610 may be a “recipe” that combines pulse generation, pulse picking, amplification, and packet shaping to yield a packet with the requested characteristics or properties.

In step 620, the system creates pulses according to the calculated recipe. Often, more pulses will be generated than will be emitted. As such, the recipe may incorporate cooperation among the pulse generator 210, pulse picker 220, amplifier 230, and packet shaper 240.

In step 630, the controller 260 operates the pulse picker 220 to tailor pulses prior to amplification. Tailoring can include blocking some pulses, which may allow a longer amplifier charging time for subsequent pulses. Tailoring can also include attenuating (e.g., reducing the energy of) pulses.

Step 640 comprises amplification of the pulses that have passed through the pulse picker 220. This step is optional if amplification is not required. Amplifier gain may be constant, may be a function of charging time, or may be independently controlled by the controller 260.

In step 650, the controller 260 operates the packet shaper 240 to select a subset of the amplified pulses. This selection creates one or more packets, each typically containing a plurality of pulses. These packets are subsequently emitted from the packet shaper 240.

Control of any component, but particularly the pulse generator 210, pulse picker 220, amplifier 230, and packet shaper 240, can optionally include the use of sensing and diagnostic equipment to measure the output packets. In some embodiments, the controller 260 incorporates these measurements to modify and/or maintain pulse and packet fidelity (e.g., the system operates with “closed loop” control). This equipment may include partially reflective mirrors that deflect a fraction of light into an optical measurement device. Such devices include diodes, charge coupled devices or other photosensitive equipment.

Any of the components such as the controller 260, pulse generator 210, pulse picker 220, amplifier 230, and packet shaper 240 may be associated with a computer or computing device such as a handset, telephone, or terminal. Various embodiments include a processor, memory, network hardware, wireless communications hardware, input hardware, display hardware and storage. Storage may include a computer-readable medium having embodied thereon a program executable by the processor to operate the associated component.

Some applications may use control of pulse power to control ablation of multiphase or composite materials. A composite material may include a first substance that strongly absorbs a particular light, and a second substance that is more weakly absorbing. A packet power may be chosen that induces a nonlinear reaction in the first substance (e.g., resulting in ablation or decomposition of the substance), and a linear reaction in the second substance (e.g., heating, or even substantially no reaction). Applications such as photothermolysis may include the use of appropriately emitted packets having controlled packet powers.

The above description is illustrative and not restrictive. Many variations of the present invention will become apparent to those of skill in the art upon review of this disclosure. The scope of the present invention should, therefore, be determined not with reference to the above description, but instead should be determined with reference to the appended claims along with their full scope of equivalents.

What is claimed is:

1. A light source comprising:
a pulse generator configured to generate a first series of light pulses having a first period;
a pulse picker configured to receive the first series and transmit a second series, the second series having a second period;
a packet shaper configured to receive the second series and transmit one or more packets, each packet comprising one or more light pulses; and
a controller in communication with the pulse generator, pulse picker, and packet shaper, the controller configured to control a packet power associated with the transmitted packets.

2. The light source of claim 1, wherein one or more of the light pulses in the first series of light pulses has a pulse width of less than 100 nanoseconds.

3. The light source of claim 1, wherein at least some of the packets have a packet width of greater than one nanosecond.

4. The light source of claim 1, further comprising an amplifier disposed between the pulse picker and the packet shaper, the amplifier configured to amplify the light pulses.

5. The light source of claim 1, further comprising a stretcher to stretch the first series of light pulses.

6. The light source of claim 1, further comprising a compressor to compress the packets of light pulses.

7. The light source of claim 4, wherein an amplified pulse energy is controlled by controlling the second period.

8. The light source of claim 4, wherein an amplified pulse energy is controlled by controlling a gain of the amplifier.

9. The light source of claim 1, wherein the pulse generator comprises a mode locked laser.

10. The light source of claim 1, wherein any of the pulse picker and packet shaper comprises an optical modulator selected from a group consisting of an acousto-optic modulator, an electro-optic modulator, a Pockels Cell, a micro-mirror, and a long period fiber grating.

11. The light source of claim 1, wherein the controller is configured to control packet power to be between 10 watts and 1 Gigawatt.

12. The light source of claim 1, wherein the controller and packet shaper are configured to transmit a first packet having a first packet power and a second packet having a second packet power, and the powers of the first and second packets differ by a factor of at least 10.

13. The light source of claim 12, wherein the first packet power is greater than one megawatt and the second packet power is less than 100 kilowatts.

14. The light source of claim 12, wherein the light source is configured to illuminate a substance, the first packet power is controlled to cause a linear response in the substance, and the second packet power is controlled to cause a nonlinear response in the substance.

15. The light source of claim 4, wherein the pulse picker is configured to attenuate a pulse prior to amplification.

16. A method of emitting one or more packets of light, each packet including one or more pulses of light, the method comprising:
receiving a request for one or more packets, the request including a desired packet energy, a packet width, and a packet power;
calculating a set of packet properties based on the request, the set including one or more properties describing the pulses within the packet;
generating the pulses according to the set of packet properties;
controlling a packet shaper to shape the pulses into one or more packets according to the set of packet properties; and
emitting the one or more packets from the packet shaper.

17. The method of claim 16, wherein the request further includes a number of pulses of light in at least one of the one or more packets of light.

18. The method of claim 16, wherein the request further includes a requested pulse energy of a pulse of light in at least one of the one or more packets of light.

19. The method of claim 16, wherein the request further includes a requested period between two or more pulses of light in at least one of the one or more packets of light.

20. The method of claim 16, further comprising amplifying the generated pulses prior to controlling the packet shaper.

21. The method of claim 16, wherein the request includes a request for a plurality of packets separated by a packet period.

22. The method of claim 16, wherein calculating includes incorporating input from an analytical device that analyzes an interaction between the emitted packets and a substance.

23. The method of claim 22, wherein the analytical device includes an apparatus configured to perform spectroscopic measurements associated with the interaction.

24. The method of claim 22, wherein the analytical device includes an apparatus configured to measure a chemical composition of a species associated with the substance.

25. The light source of claim 1, wherein the controller is further configured to control the packet power such that the transmitted packets induce a nonlinear response in a material comprising tissue.

26. The light source of claim 1, wherein the controller is further configured to receive input from an analytical device that analyzes an interaction between the transmitted packets and a substance.

27. The light source of claim 28, wherein the interaction associated with a first transmitted packet is incorporated into the control of a packet power associated with a second transmitted packet.
